(19) United States
(12) Patent Application Publication
(10) Pub. No.: US 2017/0351129 A1
(43) Pub. Date: Dec. 7, 2017

(54) LIQUID CRYSTAL DISPLAY DEVICE

(71) Applicant: Japan Display Inc., Tokyo (JP)

(72) Inventors: Masateru MORIMOTO, Tokyo (JP); Koichi IGETA, Tokyo (JP)

(21) Appl. No.: 15/611,860

(22) Filed: Jun. 2, 2017

(30) Foreign Application Priority Data
Jun. 6, 2016 (JP) 2016-112712

(51) Int. Cl. G02F 1/1368; G02F 1/1333; G02F 1/1343; G02F 1/1362; G02F 1/1339

(52) U.S. Cl. CPC G02F 1/1368; G02F 1/136286; G02F 1/13394; G02F 1/134363; G02F 1/133345; G02F 1/13624; G02F 2201/121; G02F 2201/501; G02F 2202/02

(57) ABSTRACT

The present invention addresses a display unevenness in a corner of a display in an IPS liquid crystal display device. A liquid crystal display device includes: a TFT substrate including pixels formed between scanning lines extending in a first direction and arrayed in a second direction and image signal lines extending in the second direction and arrayed in the first direction, each pixel including a TFT; a counter substrate; and a liquid crystal layer between the TFT substrate and the counter substrate, wherein a common electrode is formed above the image signal line via an insulating film, the scanning line and the end portion of the common electrode do not overlap each other as seen from the above, and they have a space d1 in the first direction.

### CLAIM OF PRIORITY

The present application claims priority from Japanese Patent Application JP 2016-112712 filed on Jun. 6, 2016, the content of which is hereby incorporated by reference into this application.

### BACKGROUND OF THE INVENTION

### (1) Field of the Invention

The present invention relates to a display device, and specifically to an IPS liquid crystal display device addressing an issue of display unevenness derived from ion accumulation.

### (2) Description of the Related Art

In a liquid crystal display device, a TFT substrate including pixels formed therein as a matrix, each pixel having a pixel electrode and a thin film transistor (TFT), and a counter substrate opposing the TFT substrate are arranged to form a display panel by sandwiching a liquid crystal layer between the TFT substrate and the counter substrate. An image is displayed by controlling light transmission with respect to each pixel using liquid crystal molecules.

The liquid crystal layer contains ions, and when ions are accumulated at a certain location due to an electric field, a black stain-like mark may be displayed to cause a display unevenness. Japanese Unexamined Patent Application Publication No. HEI3-167529 describes a configuration of removing a laminated film from a part of a gate bus line to form a portion coated only by an alignment film, trapping ions in this portion, and removing an ionized impurity having infused in the liquid crystal layer.

### SUMMARY OF THE INVENTION

While such a liquid crystal display device presents a problem of viewing angle characteristics, an IPS (In Plane Switching) system allows liquid crystal molecules to rotate in a direction parallel to a main surface of the TFT substrate, thereby presenting excellent viewing angle characteristics. In the IPS system, a common electrode and a pixel electrode are overlapped with an insulating film interposed between them. Thus, the IPS system is characterized in that the common electrode is also formed on the TFT substrate.

In the IPS system having such an electrode structure, due to the fact that the common electrode is formed on the whole display panel as shown in FIG. 2, ions in the liquid crystal layer are accumulated in a certain corner to be displayed as a black stain-like mark, resulting in a phenomenon of causing the display unevenness. Arrows 2 in FIG. 2 indicate movements of ions. FIG. 2 schematically shows that the ions are accumulated in a top right corner of a display region 1000 causing a display unevenness 3. If a frame 1100 is reduced in width to increase an area of the display region, the frame 1100 that covers pixels in a peripheral region of the display panel is also narrowed, and consequently the display unevenness 3 due to the ions accumulated at the corner becomes more noticeable.

It is an object of the present invention to provide a configuration that causes no display unevenness at a corner of a display.

The present invention is made to overcome the above-described problems, and its typical implementations are as follows: (1) a liquid crystal display device including: a TFT substrate including a plurality of scanning lines, a plurality of image signal lines extending in a second direction, and a plurality of switching elements formed on each pixel; a counter substrate; and a liquid crystal layer sandwiched between the TFT substrate and the counter substrate, wherein a common electrode is formed on a side of the image signal line facing the liquid crystal layer via an insulating film, the common electrode is formed continuously across a plurality of pixels along an extending direction of the scanning lines as viewed from above and also has a gap at a position superimposed with the scanning line, an end portion of the common electrode is arranged with a space d1 from the scanning line as seen from above, and when a distance between the scanning-line forming layer and the common-electrode forming layer is assumed h1 as seen in a sectional view of the TFT substrate, the space d1 between the scanning line and the end portion of the common electrode is larger than the distance h1.

(2) A liquid crystal display device including: a TFT substrate including a plurality of scanning lines, a plurality of image signal lines, and a plurality of switching elements formed on each pixel; a counter substrate; and a liquid crystal layer sandwiched between the TFT substrate and the counter substrate, wherein a first electrode is formed on a side of the image signal line facing the liquid crystal layer via a first insulating film, a second electrode is formed on the first electrode with a second insulating film interposed in between, either one of the first electrode and the second electrode is a common electrode, the common electrode is formed continuously across a plurality of pixels along an extending direction of the scanning lines as viewed from above and also has a gap at a position superimposed on the scanning line, an end portion of the common electrode is arranged with a space d1 from the scanning line as seen from above, and the liquid crystal display device includes at a position of the gap d1 a concave region where the first insulating film is thinner.

### BRIEF DESCRIPTION OF THE DRAWINGS

FIG. 1 is a schematic plan view showing a mechanism of the present invention;

FIG. 2 is a schematic plan view showing a display unevenness derived from ion accumulation;

FIG. 3A is a cross-sectional view of a liquid crystal display device;

FIG. 3B is a plan view of a pixel arrangement;

FIG. 4 is a plan view of a pixel in the liquid crystal display device according to an embodiment of the present invention;

FIG. 5 is a cross-sectional view taken along a line A-A in FIG. 4;

FIG. 6 shows an example of a driving voltage of the liquid crystal display device;

FIG. 7 shows another example of the driving voltage of the liquid crystal display device;

FIG. 8 is a plan view of a first embodiment;

FIG. 9 is a cross-sectional view taken along a line B-B in FIG. 8;

FIG. 10 is a cross-sectional view showing a mechanism of the first embodiment;

FIG. 11 shows equipotential lines in the liquid crystal display device according to a comparative example;

FIG. 12 shows equipotential lines in the liquid crystal display device according to the first embodiment;

FIG. 13 is a plan view showing a first implementation of the first embodiment;

FIG. 14 is a plan view showing a mechanism of a second embodiment;

FIG. 15 is a cross-sectional view showing the mechanism of the second embodiment;

FIG. 16 shows equipotential lines in the liquid crystal display device according to the comparative example;

FIG. 17 shows equipotential lines in the liquid crystal display device according to the second embodiment;

FIG. 18 is a plan view showing a first implementation of the second embodiment;

FIG. 19 is a plan view showing a second implementation of the second embodiment; and

FIG. 20 is a plan view showing a third implementation of the second embodiment.

### DETAILED DESCRIPTION OF THE INVENTION

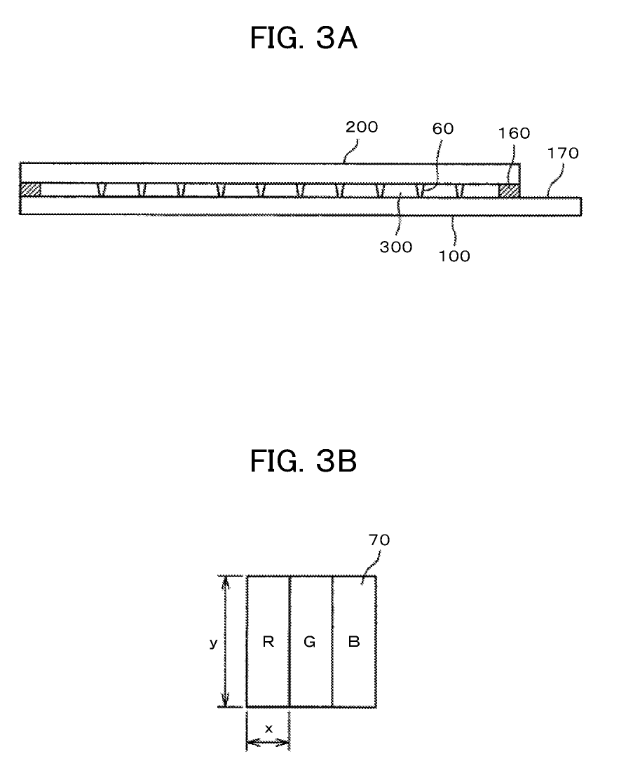

FIG. 3A is a schematic cross-sectional view of a liquid crystal display device. In FIG. 3A, a counter substrate 200 is arranged facing a TFT substrate on which pixels formed with a TFT and a pixel electrode thereon are formed as a matrix, and a liquid crystal layer 300 is sandwiched between the TFT substrate 100 and the counter substrate 200. The liquid crystal layer 300 is sealed by a peripheral seal material 160. A space between the TFT substrate 100 and the counter substrate 200 is defined by a columnar spacer 60 formed on the counter substrate 200. The TFT substrate 100 is made larger than the counter substrate 200, and a region of the TFT substrate 100 not facing the counter substrate 200 is a terminal portion 170 for connecting an IC driver, a flexible wiring substrate, and the like.

FIG. 3B is a plan view showing an arrangement of a pixel 70 formed on the TFT substrate 100 and the counter substrate 200. The pixel is constituted by a red pixel R corresponding to a red color filter, a green pixel G corresponding to a green color filter, and a blue pixel B corresponding to a blue color filter, and the pixels 70 are arranged all over the display region. As resolution of a display increased recently, the size of the pixel 70 is reduced, and values of x and y indicated in FIG. 3B are now very small. For example, in the liquid crystal display device having a TFT using a-Si (amorphous-Silicon) described in the following embodiments, x=30 μm and y=90 μm approximately, in a liquid crystal display device having a TFT using LTPS (Low Temperature Poly-Silicon), x=20 μm and y=60 μm, and in some other liquid crystal display devices, the size can be even x=15 μm and y=45 μm.

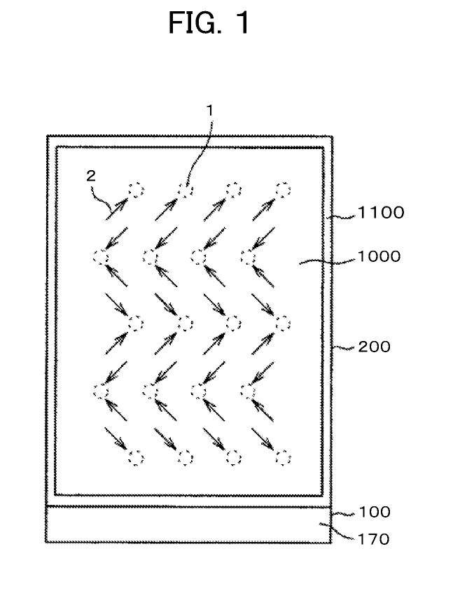

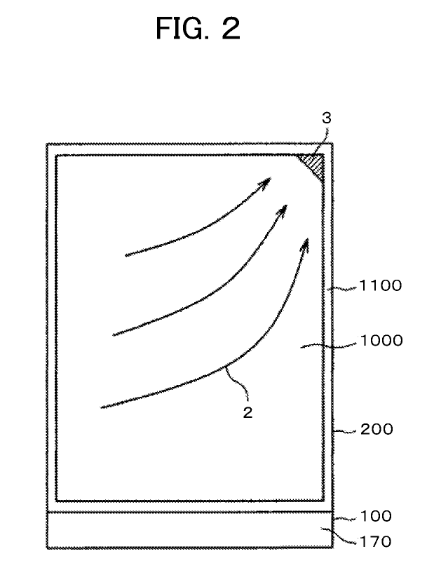

FIG. 1 is a schematic plan view showing a mechanism of the present invention. In FIG. 1, liquid crystal is sandwiched between the TFT substrate 100 and the counter substrate 200. A periphery of the display region is made as a frame region 1100, where the seal material 160 shown in FIG. 3A is formed. In the display region 1000, the arrows 2 indicate a moving direction of ions. Each site indicated by a dotted circle in FIG. 1 is an ion accumulation site. In FIG. 1, because many ion accumulation sites 1 are formed and not too many ions are accumulated in each site, there cannot occur a display unevenness.

The present invention uses a potential of a scanning line to which a gate voltage is applied as an ion trap by acting the potential on the liquid crystal layer. Furthermore, as shown in FIG. 1, by forming many sites for accumulating ions in the display region, it is prevented that too many ions are accumulated in a specific site, thereby preventing the display unevenness. The present invention will be described in detail with reference to embodiments below.

### First Embodiment

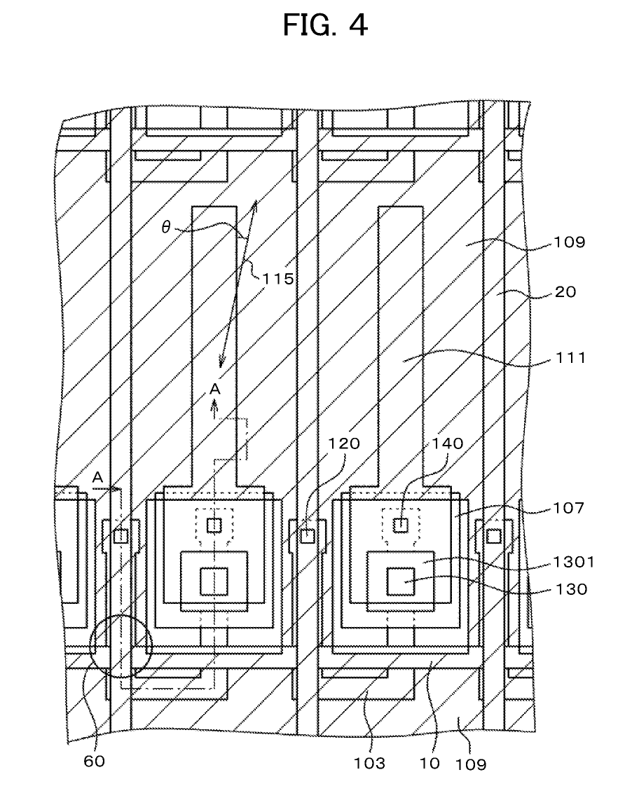

FIG. 4 is a plan view showing a pixel structure of an IPS liquid crystal display device according to the present invention. The IPS system includes various pixel structures, and the main stream system includes: forming the common electrode in a flat shape; arranging a comb-teeth-shaped pixel electrode on it with an insulating film interposed in between; and rotating liquid crystal molecules by an electric field generated between the pixel electrode and the common electrode, because it allows for a relatively high transmission.

In FIG. 4, a plurality of scanning lines 10 extend in a lateral direction with a predetermined space between them in a longitudinal direction. The longitudinal space between the scanning lines 10 defines the longitudinal size of the pixel. Furthermore, a plurality of image signal lines 20 extend in the longitudinal direction with a predetermined space between them in the lateral direction. The lateral space between the image signal lines 20 defines the lateral size of the pixel. Formed near an intersection of the scanning line 10 and the image signal line 20 is a columnar spacer 60 for defining a space between the TFT substrate 100 and the counter substrate 200.

A stripe-like pixel electrode 111 extends in the longitudinal direction in the pixel. Although the pixel electrode 111 is like a single line in FIG. 4, in order to improve the transmission, the pixel electrode 111 may also be a comb-teeth-shaped electrode having a slit by widening the space between the pixels or improving the fineness of the electrode processing.

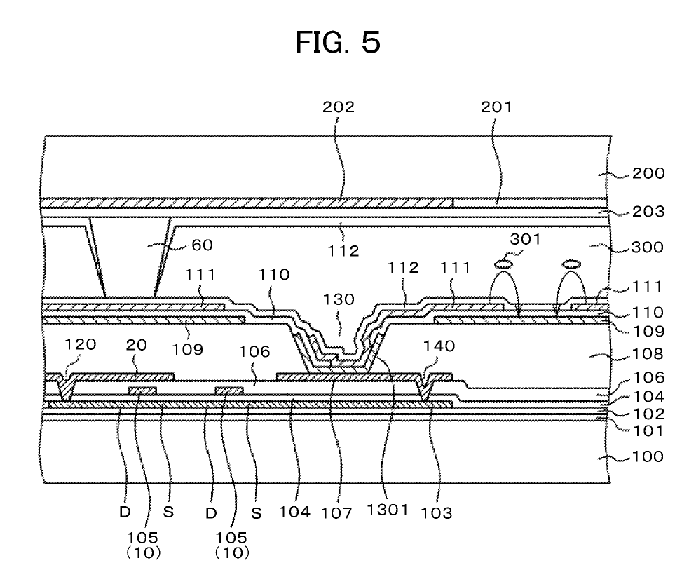

The pixel electrode 111 is supplied with image signals from the image signal line 20 via the through-hole and the TFT. In FIG. 4, the image signal line is connected to the semiconductor layer 103 via the through-hole 120. The semiconductor layer 103 extends below the image signal line 20, passes underneath the scanning line 10, bends and passes underneath the scanning line 10 again, and then connected to a contact electrode 107 via a through-hole 140. The contact electrode 107 is connected to the pixel electrode 111 via a through-hole 130. Relation between the through-hole 130 and a hole electrode 1301 will be described with reference to FIG. 5. The TFT is formed when the semiconductor layer 103 passes underneath the scanning line 10. In this case, the scanning line 10 also takes a role of a gate electrode. Thus, in FIG. 4, two TFTs are formed from the image signal line 20 to the pixel electrode 111, which is a so-called double gate TFT.

In FIG. 4, a direction of an alignment axis 115 formed in an alignment film makes an angle θ with an extending direction of the pixel electrode 111. The angle θ is formed in order to specify the rotating direction of the liquid crystal molecules when the electric field is applied to the pixel electrode 111. The angle may be approximately 5 to 15 degrees. There may be cases in which the direction of the alignment axis 115 is parallel to the extending direction of the scanning line 20 and the extending direction of the pixel electrode 111 is inclined by the angle θ. FIG. 4 shows the case in which the dielectric constant anisotropy of the liquid crystal molecules is positive. When the dielectric constant anisotropy of the liquid crystal is negative, the angle of the alignment axis is rotated from that in FIG. 1 by 90 degrees.

In the configuration shown in FIG. 4, the common electrode is formed on the whole surface except the periphery of the through-hole 130. Most part of the scanning line 10 is also covered by the common electrode 109. Thus, the electric field caused by the signals flowing through the scanning line 10 and the image signal line 20 hardly leaks into the liquid crystal layer. The feature of the present invention is, as described later, removing the common electrode 109 as much as possible near the scanning line 10 to have the electric field caused by the signals flowing through the scanning line 10 and the image signal line 20 penetrate into the liquid crystal layer, and trapping an impurity by the electric field.

FIG. 5 is a cross-sectional view taken along a line A-A in FIG. 4. The TFT shown in FIG. 5 is a so-called top-gate-type TFT, using LTPS as a semiconductor. On the other hand, when using an a-Si semiconductor, a so-called bottom-gate-type TFT is used in many cases. It should be noted that, although the description is given below taking an example of using the top-gate-type TFT, the present invention can also be applied to the case in which the bottom-gate-type TFT is used.

In FIG. 5, a first base film 101 made of SiN and a second base film 102 made of SiO₂ are formed on a glass substrate 100 by CVD (Chemical Vapor Deposition). The role of the first base film 101 and the second base film 102 is to prevent contamination of the semiconductor layer 103 by the impurity from the glass substrate 100.

The semiconductor layer 103 is formed on the second base film 102. The semiconductor layer 103 is made by forming an a-Si film on the second base film 102 by the CVD and converting it to an LTPS poly-Si film by the laser annealing. The poly-Si film is patterned by the photolithography.

Formed on the semiconductor film 103 is a gate insulating film 104. The gate insulating film 104 is an SiO₂ film using TEOS (Tetraethyl Orthosilicate). This film is also formed by the CVD. A gate electrode 105 is formed on it. The function of the gate electrode 105 is combined by the scanning line 10. The gate electrode 105 is formed of, for example, a MoW (Molybdenum Tungsten) film. When it is required to reduce resistance of the gate electrode 105 or the scanning line 10, an Al (Aluminum) alloy is used.

An interlayer insulating film 106 is then formed of SiO2 or SiN by coating the gate electrode 105. The interlayer insulating film 106 is formed in order to insulate the gate electrode 105 from the image signal line 20. The semiconductor layer 103 is connected to the image signal line 20 via the through-hole 120 formed between the gate insulating film 104 and the interlayer insulating film 106. Furthermore, formed in the interlayer insulating film 106 and the gate insulating film 104 is the through-hole 140 to connect a source S of the TFT to the contact electrode 107. The through-hole 120 and the through-hole 140 formed in the interlayer insulating film 106 and the gate insulating film 104 are formed at the same time.

The contact electrode 107 is formed on the interlayer insulating film 106. The semiconductor layer 103 extends underneath the image signal line 20 and, as shown in FIGS. 4 and 5 passes underneath the scanning line 10, namely the gate electrode 105, two times. At this time, the TFT is formed. That is, as seen from above, the source S and a drain D of the TFT are formed with the gate electrode 105 interposed between them. The contact electrode 107 is connected to the semiconductor layer 103 via the through-hole 140 formed in the interlayer insulating film 106 and the gate insulating film 104.

The contact electrode 107 and the image signal line 20 are formed in the same layer at the same time. The contact electrode 107 and the image signal line 20 use, for example, an Al—Si alloy to reduce the resistance. Because the Al—Si alloy can form a hillock and allow Al to diffuse to another layer, it employs a structure of, for example, sandwiching the Al—Si alloy between a barrier layer and a cap layer containing MoW.

An organic passivation film 108 is formed covering the contact electrode 107, the image signal line 20, and the interlayer insulating film 106. The organic passivation film 108 is formed of a photosensitive acrylic resin. Besides the acrylic resin, the organic passivation film 108 can be formed of silicone resin, epoxy resin, polyimide resin, and the like. The organic passivation film 108 is formed thick because it functions as a flattening film. Thickness of the organic passivation film 108 can be 1 to 4 μm, and it is typically 2 to 3 μm.

In order to electrically connect the pixel electrode 111 to the contact electrode 107, the through-hole 130 is formed in the organic passivation film 108. The organic passivation film 108 uses a photosensitive resin. By exposing the photosensitive resin to light after being applied, only the exposed portion can be dissolved in a specific developer. That is, by using the photosensitive resin, formation of photoresist can be eliminated. After forming the through-hole 130 in the organic passivation film 108, it is baked at approximately 230° C., whereby the organic passivation film 108 is completed.

ITO (Indium Tin Oxide) to be the common electrode 109 is then formed by sputtering, and patterning is performed so as to remove ITO from the periphery of the through-hole 130. The common electrode 109 can be formed planar in common with each electrode. A part of ITO formed as the common electrode 109 is left in the through-hole 130 to be used as a hole electrode 1301 that connects the pixel electrode 111 to the contact electrode 107. The hole electrode 1301 is connected to the contact electrode 107 and also to the pixel electrode 111, but not to the common electrode 109.

Next, SiN to be a capacitor insulating film 110 is formed on the whole surface by the CVD. Then, in the through-hole 130, a through-hole for electrically connecting the hole electrode 1301 to the pixel electrode 111 is formed in the capacitor insulating film 110.

ITO is then formed by sputtering, and the pixel electrode 111 is formed by patterning. An exemplary flattened shape of the pixel electrode 111 is shown in FIG. 4. An alignment film material is applied to the pixel electrode 111 by flexographic printing, ink-jet printing, or the like, and baked to form an alignment film 112. For an alignment process of the alignment film 112, an optical alignment using a polarized ultraviolet light is used as well as a rubbing method.

When a voltage is applied between the pixel electrode 111 and the common electrode 109, an electric power line is generated as indicated by arrows in FIG. 5. This electric field rotates liquid crystal molecules 301 to control an amount of the light passing through the liquid crystal layer 300 with respect to each pixel, thereby forming an image.

In FIG. 5, the counter substrate 200 is formed with the liquid crystal layer 300 interposed. A color filter 201 is formed on the inner side of the counter substrate 200. Red, green, and blue color filters are formed on the color filter 201 with respect to each pixel, which makes it possible to form a color image. A black matrix 202 is formed between the color filters 201, thereby improving the image contrast. The black matrix 202 also functions as a light shielding film of the TFT that prevents a photocurrent from flowing into the TFT.

An overcoat film 203 is formed covering the color filter 201 and the black matrix 202. Due to rough surfaces of the color filter 201 and the black matrix 202, the overcoat film 203 flattens the surfaces. Formed on the overcoat film 203 is the alignment film 112 for determining the initial alignment of the liquid crystal. For the alignment process of the alignment film 112, either the rubbing method or the optical alignment method is used as with the alignment film 112 on the TFT substrate 100.

In FIG. 5, a columnar spacer 60 is formed to keep a space between the TFT substrate and the counter substrate and retain a constant thickness of the liquid crystal layer. The columnar spacer 60 may be formed on the overcoat film 203 of the counter substrate 200, or otherwise formed at the same time as the overcoat film 203. Because the alignment of the liquid crystal molecules may be inconsistent in a portion where the columnar spacer 60 is formed, resulting in a light leak, the black matrix 202 is formed on the corresponding portion of the counter substrate 200.

The above configurations are merely examples and, for example, depending on the product, in the TFT substrate 100, an inorganic passivation film containing SiN or the like may be formed between the contact electrode 107 or the image signal line 20 and the organic passivation film 108.

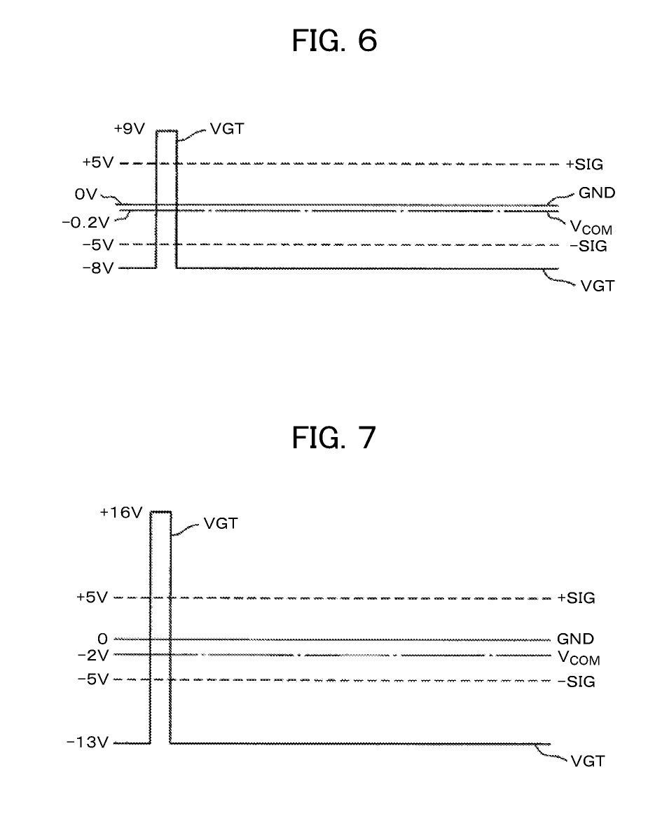

FIG. 6 shows an example of voltages applied to each electrode when the top-gate-type TFT is formed using the Poly-Si film as the semiconductor layer as shown in FIGS. 4 and 5. In FIG. 6, GND indicates a ground potential, and +SIG and −SIG indicate a maximum positive value and a maximum negative value of the image signal, respectively. The image signal is applied to the pixel electrode 111 periodically varying its polarity. Vcom indicates a voltage applied to the common electrode 109, which is typically constant. VGT indicates a voltage of a gate signal applied to the gate electrode 105 (scanning line 10), which is usually −8 V and is +9 V only when the TFT is turned on.

FIG. 7 shows an example of voltages applied to each electrode in the liquid crystal display device using the bottom-gate-type TFT using a-Si as the semiconductor layer. In FIG. 7, GND indicates the ground potential, and +SIG and −SIG indicate the maximum positive value and the maximum negative value of the image signal, respectively. The image signal is applied to the pixel electrode periodically varying its polarity. Vcom indicates the voltage applied to the common electrode 109, which is typically constant. VGT indicates the voltage of the gate signal applied to the gate electrode (scanning line), which is usually −13 V and is +16 V only when the TFT is turned on.

As shown in FIGS. 6 and 7, the voltage of the gate signal applied to each scanning line (gate electrode) is always a high negative potential except when the scanning line is selected. In other words, the potential is negative most of the time. The present invention uses the negative potential as an ion trap.

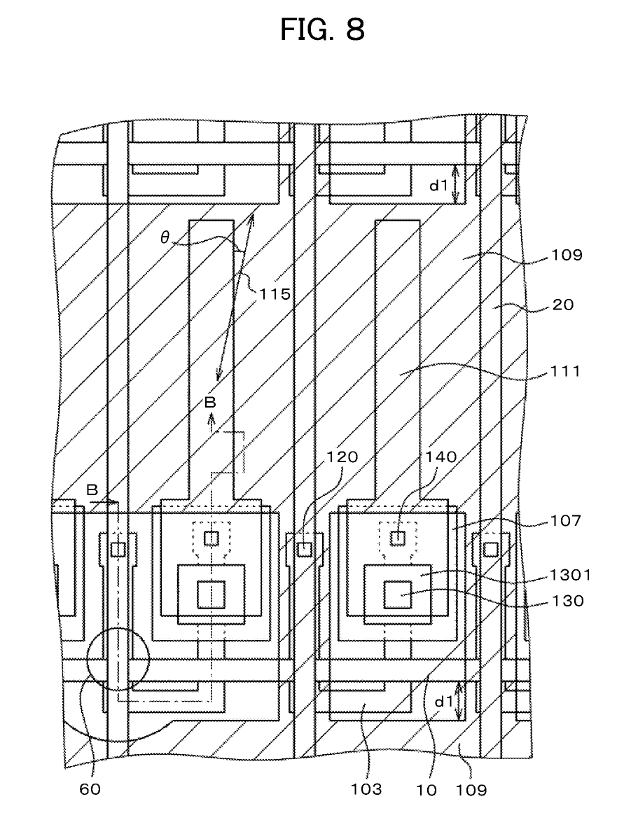

FIG. 8 is a plan view of a pixel portion of the liquid crystal display device showing features of the present invention. FIG. 8 is different from FIG. 4 in terms of an area in which the common electrode 109 is formed. In FIG. 8, the common electrodes 109 are connected to one another at the top and bottom by a bridge electrode formed in the same layer as the common electrode beside the through-hole 130. The connection between the upper common electrode 109 and the lower common electrode 109 need not be made with respect to each pixel, but there may be, for example, two connections for three pixels. In this manner, because the bridge electrode does not exist between every common electrode 109, the pixel pitch can be made smaller in the horizontal direction.

The feature of the embodiment shown in FIG. 8 is that the common electrode 109 opens wide at the scanning line 10 as seen from the above. In FIG. 8, a distance between an end portion of the scanning line 10 and an end portion of the common electrode 109 is denoted by d1. Thus, by setting the end portion of the common electrode 109 back from the scanning line 10 as seen from the above, the gate voltage having a large negative potential penetrates into the liquid crystal layer 300, thereby collecting ions in this location. In the present invention, because such locations are formed uniformly along the scanning line 10, ions are trapped along the scanning line 10. If ions are accumulated excessively, the transmission of the liquid crystal layer in this location lowers resulting in a black stain. However, because the region along the scanning line 10 is covered by the black matrix 202, the display is not affected and thus occurrence of the display unevenness can be prevented.

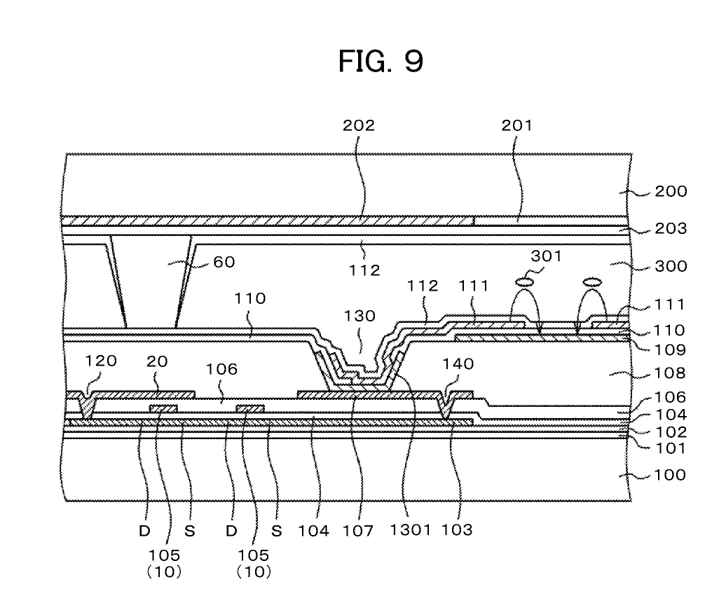

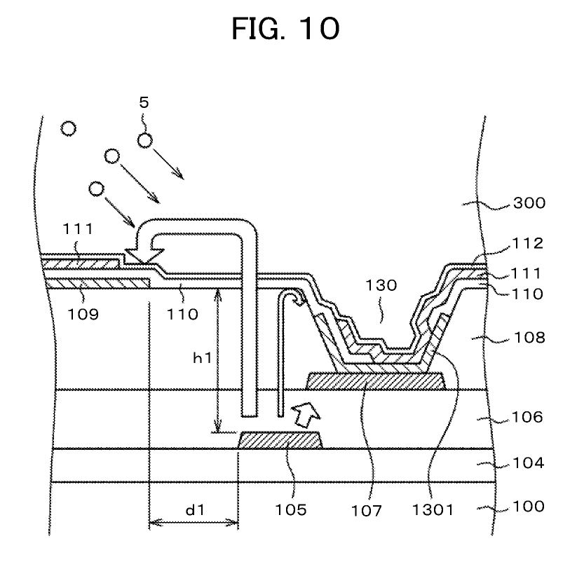

FIG. 9 is a cross-sectional view taken along a line B-B in FIG. 8. FIG. 9 is different from FIG. 5 in that the common electrode 109 is not present at a position corresponding to the gate electrode 105 (scanning line 10). That is, because the common electrode 109 is absent, the gate voltage can penetrates into the liquid crystal layer 300 to accumulate ions. In FIG. 9, the image signal line 20 is present on the left gate electrode 105, but this is where the scanning line 10 intersects with the image signal line 20 and most part of the scanning line 10 does not overlap the image signal line 20. Accordingly, the gate voltage can penetrate into the liquid crystal layer 300.

FIG. 10 is a cross-sectional view showing a principle of the present invention. For clarity of illustration, some layers are not shown in FIG. 10. In FIG. 10, the gate electrode 105 (scanning line 10) is formed on the TFT substrate 100, and the interlayer insulating film 106 is formed to cover the gate electrode 105. The organic passivation film 108 is formed on the interlayer insulating film 106, and the through-hole 130 is formed in the organic passivation film 108 for connection with the contact electrode 107 that connects the pixel electrode 111 to the TFT.

The common electrode 109 is formed on the organic passivation film 108, but the common electrode 109 sets back near the gate electrode 105 (scanning line 10) to form an opening, as seen from the above. Thus, because the common electrode 109 is not present on the gate electrode 105 (scanning line 10), the electric field from the gate electrode 105 (scanning line 10) penetrates into the liquid crystal layer 300, thereby collecting ions 5 at the capacitor insulating film 110 in the opening of the common electrode 109.

In order to obtain a sufficient effect of the present invention, the distance d1 from the end portion of the gate electrode 105 (scanning line 10) to the end portion of the common electrode 109 is important. The distance d1 is preferably 3 μm or more, and also preferably longer than a distance h1 from the upper end of the gate electrode 105 (scanning line 10) to the upper end of a layer in which the common electrode 109 is formed (organic passivation film 108 in FIG. 10).

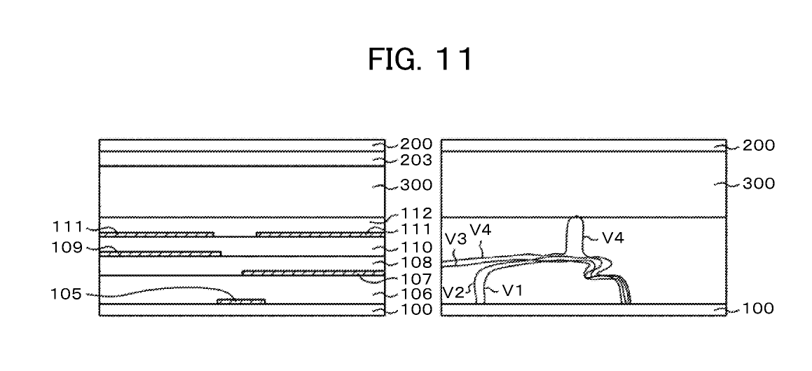

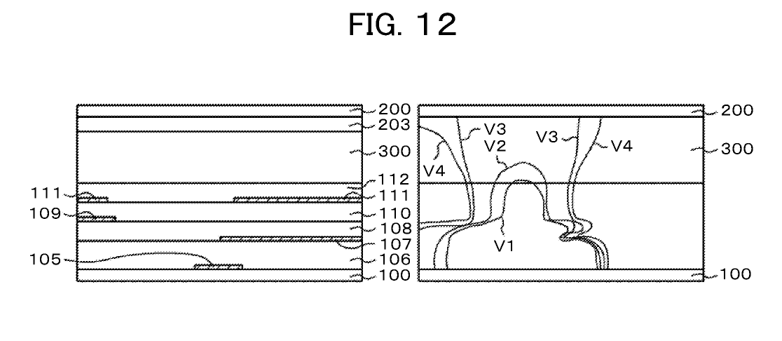

FIGS. 11 and 12 show the results of electric field simulations indicative of the effect of the invention. FIG. 11 shows the result of a comparative example in which the opening of the common electrode 109 is smaller. Shown on the left is a layer structure used for the simulation. In FIG. 11, the gate electrode 105 is formed on the TFT substrate 100, the interlayer insulating film 106 is formed to cover the gate electrode 105, and the contact electrode 107 is further formed on it. The organic passivation film 108 is formed to cover the contact electrode 107, the common electrode 109 is formed on it, the capacitor insulating film 110 is formed to cover it, and then the pixel electrode 111 is formed on it. The uppermost layer is the alignment film 112, on which the liquid crystal layer 300 is formed, and the overcoat film 203 is formed on the counter substrate 200 with the liquid crystal layer 300 interposed between them.

Shown on the right of FIG. 11 is a chart showing equipotential lines in a case in which the gate signal is applied to the gate electrode 105 (scanning line 10) to turn the TFT on in the layer structure shown on the left. In FIG. 11, the potential of the equipotential line V1 is the lowest, and the potential increases in the order of V2, V3, and V4. V1 is the closest to the gate voltage. In other words, if the equipotential lines V1, V2 and the like penetrate into the liquid crystal layer, a remarkable ion trap can be expected, but V1 to V4 hardly penetrate into the liquid crystal layer in the comparative example, exhibiting a very little effect of trapping ions.

FIG. 12 shows a simulation result indicative of the ion trapping effect according to the invention. The layer structure on the left of FIG. 12 is the same as FIG. 11 except that the common electrode 109 and the pixel electrode 111 are set back to the left and the opening of the common electrode 109 is formed larger. Shown on the right of FIG. 12 is a chart showing equipotential lines in a case in which the gate signal is applied to the gate electrode 105 (scanning line 10) to turn the TFT on in the layer structure shown on the left.

In the right chart of FIG. 12, the equipotential lines V3 and V4 penetrate deep into the liquid crystal layer, and the equipotential lines V1 and V2 also penetrate into the liquid crystal layer. That is, the effect of trapping ions in the liquid crystal layer 300 is much higher than that shown in FIG. 11. Thus, according to the invention, it is possible to greatly improve the ion trapping effect only by changing the area of the common electrode 109.

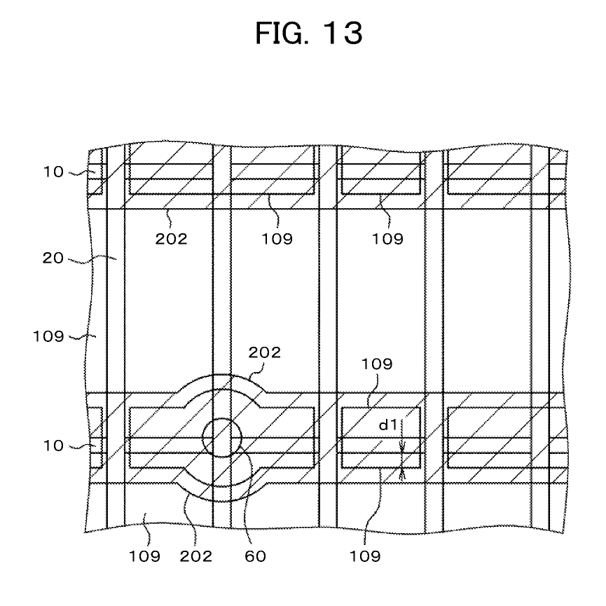

FIG. 13 is a plan view showing a specific configuration of the present invention. For the purpose of clarity, the pixel electrode, the semiconductor layer, the through-hole, and the like are not shown in FIG. 13. On the other hand, the area of the black matrix (light shielding film) 202 formed on the counter substrate is indicated by hatching.

In FIG. 13, the scanning line 10 extends in the lateral direction, the image signal line 20 extends in the longitudinal direction, and the pixel is surrounded by the scanning line 10 and the image signal line 20. Formed near the scanning line 10 are the TFT, the through-hole, the columnar spacer, and the like. Because this region is both shielded and easily leaking light, the black matrix 202 is formed on the counter substrate in a portion corresponding to this region.

Although the columnar spacer 60 is not necessarily formed in all the pixels, because the columnar spacer 60 may move due to pressure and the alignment of the liquid crystal molecule may be disturbed near the columnar spacer 60, the black matrix 202 corresponding to the columnar spacer 60 is made wider.

The feature of the embodiment shown in FIG. 13 is that the common electrode 109 is formed farther than the end portion of the scanning line 10 toward the outside. Due to this, the opening is made larger on the upper side of the scanning line 10 and the electric field formed by the scanning line 10 easily penetrates into the liquid crystal layer. The planar distance from the end portion of the scanning line 10 to the end portion of the common electrode 109 is d1, and the value of D1 is as described with reference to FIG. 10.

In FIG. 13, the common electrode 109 is not formed below or near the columnar spacer 60. This is due to the fact that there is no concern of leaking light even when the opening of the common electrode 109 is made wider because the width of the black matrix 202 is increased. On the other hand, by increasing the opening of the common electrode 109 in size near the columnar spacer 60, it is possible to further improve the ion trapping effect in this area.

The columnar spacer 60 is not necessarily formed in all the pixels. On the other hand, in an area where the columnar spacer 60 is formed, the transmission of the pixel is lower because the width of the black matrix 202 is made wider. This may cause a brightness unevenness, a color unevenness, and the like. In order to prevent these issues, there may be a case of increasing the width of the black matrix 202 in the pixel in which the columnar spacer 60 is not formed to balance the transmissions among the pixels.

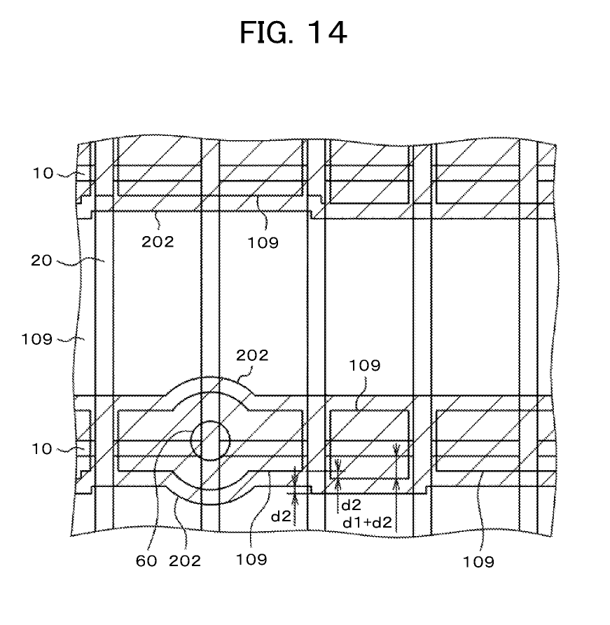

FIG. 14 is a plan view showing an example of this configuration. In FIG. 14, the pixel in which the columnar spacer 60 is not formed has a width of the black matrix 202 larger by d2. In FIG. 14, by increasing the space between the end portion of the scanning line 10 and the end portion of the common electrode 109 from d1 to (d1+d2) to compensate for the increase of the width of the black matrix 202, the effect of the electric field generated by application of the gate signal penetrating into the liquid crystal layer is increased.

In this manner, according to the embodiment of the present invention, the ion trapping effect can be improved in each pixel only by changing an area of formation of the common electrode 109, resulting in prevention of the black stain in a certain location. The embodiment also has an advantage of minimizing an increase of the production cost to obtain the above effects.

### Second Embodiment

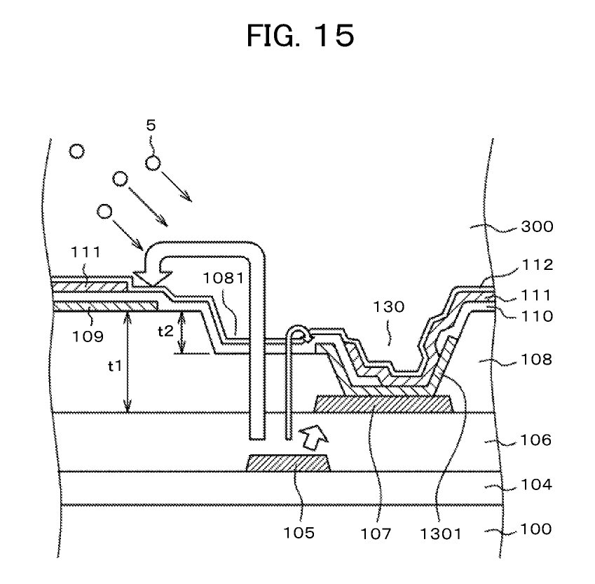

FIG. 15 is a cross-sectional view showing a principle of a second embodiment of the present invention. The feature of the second embodiment is forming a concave portion in the organic passivation film 108 above the gate electrode 105 and trapping the ions 5 in this portion. In the organic passivation film 108, because the gate voltage can have a stronger effect in the portion 1081 with a thinned layer, it is possible to improve the effect of trapping the ions 5.

For the purpose of clarity, some layers are not shown in FIG. 15. In FIG. 15, the gate electrode 105 (scanning line 10) is formed on the TFT substrate 100, the interlayer insulating film 106 is formed to cover the gate electrode 105, and the contact electrode 107 is further formed on it. The organic passivation film 108 is formed to cover the contact electrode 107, the common electrode 109 is formed on it, the capacitor insulating film 110 is formed to cover it, and then the pixel electrode 111 is formed on it.

In this embodiment, the opening of the common electrode 109 is formed wide above the gate electrode 105, as in the first embodiment In addition, the organic passivation film 108 is made thin at the opening of the common electrode 109 in this embodiment. In the portion 1081 where the organic passivation film is made thinner, the electric field generated from the gate electrode 105 has more influence than in other portions. Therefore, the ions 5 tend to accumulate in this portion. That is, it is possible to trap the ions 5 more effectively.

In FIG. 15, in order to obtain a sufficient effect of the present invention, a depth t2 of a concave portion 1081 of an organic passivation film 1081 needs to be a certain level of value. The value t2 is preferably 1 μm or more. When assuming the thickness of the organic passivation film 1081 as t1, t2≧(t1)/3, more preferably t2≧(t1)/2. Although the through-hole 130 for connection between the pixel electrode 111 and the contact electrode 107 is connected to the concave portion 1081 of the organic passivation film 108 in FIG. 15, the invention is not limited to this configuration but the concave portion 1081 of the organic passivation film 108 and the through-hole 130 may be formed independently.

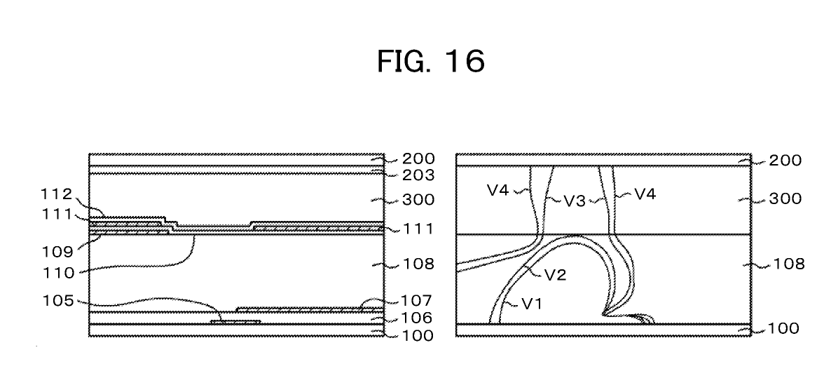

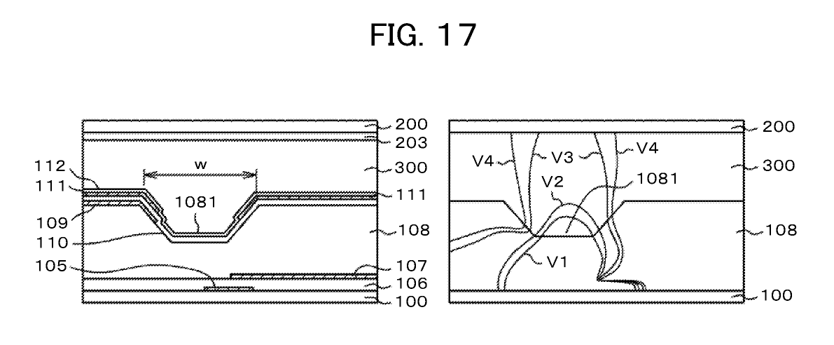

FIGS. 16 and 17 show the results of electric field simulations indicative of the effect of the invention. In FIG. 16, a wide opening is formed at the portion corresponding to the gate electrode 105 (scanning line 10), while the organic passivation film 108 is flat. Shown on the left of FIG. 16 is a layer structure used for the simulation. In FIG. 16, the gate electrode 105 (scanning line 10) is formed on the TFT substrate 100, the interlayer insulating film 106 is formed to cover the gate electrode 105, and the organic passivation film 108 is further formed on it.

Formed on the organic passivation film 108 is the common electrode 109, in which a wide opening is formed above the gate electrode 105 (scanning line 10). Present on the common electrode 109 is the liquid crystal layer 300, and the overcoat film 203 is formed on the counter substrate 200 with the liquid crystal layer 300 interposed between them.

Shown on the right of FIG. 16 is a chart showing equipotential lines in a case in which the gate signal for turning the TFT on is not applied to the gate electrode 105 (scanning line 10) in the layer structure shown on the left. In FIG. 16, the potential of the equipotential line V1 is the lowest, and the potential increases in the order of V2, V3, and V4. V1 is the closest to the gate voltage in the case where the gate signal for turning the TFT on is not applied. In other words, if the equipotential lines V1, V2 and the like penetrate into the liquid crystal layer, a remarkable ion trap can be expected.

Even in the simulation shown in FIG. 16, the potentials V3 and V4 penetrate into the liquid crystal layer, which presents a certain level of effect on the ion trap. This is the effect created by forming a wide opening of the common electrode 109 above the gate electrode 105 (scanning line 10).

FIG. 17 shows a simulation result indicative of the ion trapping effect according to the invention. The layer structure on the left of FIG. 17 is the same as FIG. 11 except that the concave portion 1081 is formed in the organic passivation film 108. In FIG. 17, the depth of the concave portion 1081 of the organic passivation film 108 is ½ of the thickness of the organic passivation film 108.

Shown on the right of FIG. 17 is a chart showing equipotential lines in a case in which the gate signal is not applied to the gate electrode 105 in the layer structure shown on the left of FIG. 17. In FIG. 17, not only the potential V2 but also the lowest potential V1 penetrate into the concave portion 1081 of the organic passivation film 108. This means that the concave portion 1081 of the organic passivation film 108 presents a very strong ion trapping effect.

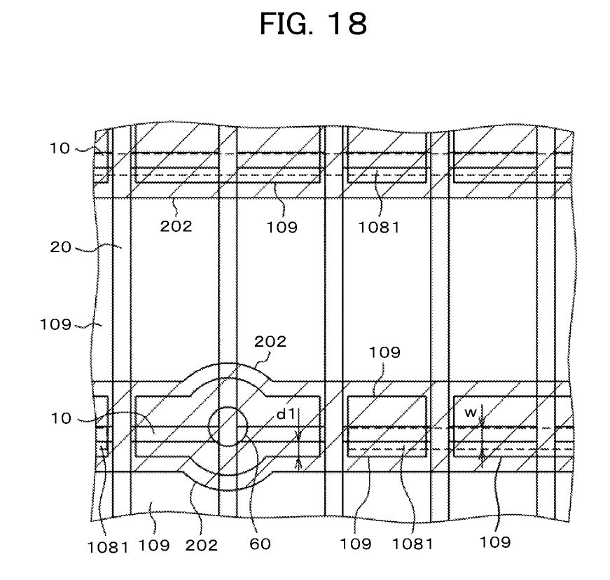

FIG. 18 is a plan view showing a specific configuration of the present embodiment. For the purpose of clarity, the pixel electrode, the semiconductor layer, the through-hole, and the like are not shown in FIG. 18. On the other hand, the area of the black matrix (light shielding film) 202 formed on the counter substrate is indicated by hatching. FIG. 18 is the same as FIG. 13 except that the organic passivation film concave portion 1081 is formed as indicated by dotted lines.

In FIG. 18, as seen from the above, the organic passivation film concave portion 1081 is formed on the scanning line 10 and between the end portion of the scanning line and the end portion of the common electrode 109. The organic passivation film concave portion 1081 is formed across a plurality of pixels. In this manner, in addition to the effect by the opening of the common electrode 109 being formed wide above the scanning line, the potential in the concave portion 1081 of the organic passivation film 108 can drastically increase the effect of trapping ions.

In FIG. 18, a width w of the organic passivation film concave portion 1081 is preferably 3 μm or more. Alternatively, it is preferably larger than the width of the scanning line 10. It should be noted that, as shown in FIG. 17, w is the value taken on the side close to the liquid crystal layer. Because too large a width of the organic passivation film concave portion 1081 may affect the alignment of the liquid crystal, it is preferred to be smaller than (width of the scanning line 10+space d1 between the end portion of the scanning line and the end portion of the pixel electrode).

On the other hand, it is better that the concave portion 1081 of the organic passivation film 108 is not formed on the pixel in which the columnar spacer 60 is formed. This is because drop of the columnar spacer 60 into the organic passivation film concave portion 1081 makes it difficult to specify the space between the TFT substrate and the counter substrate.

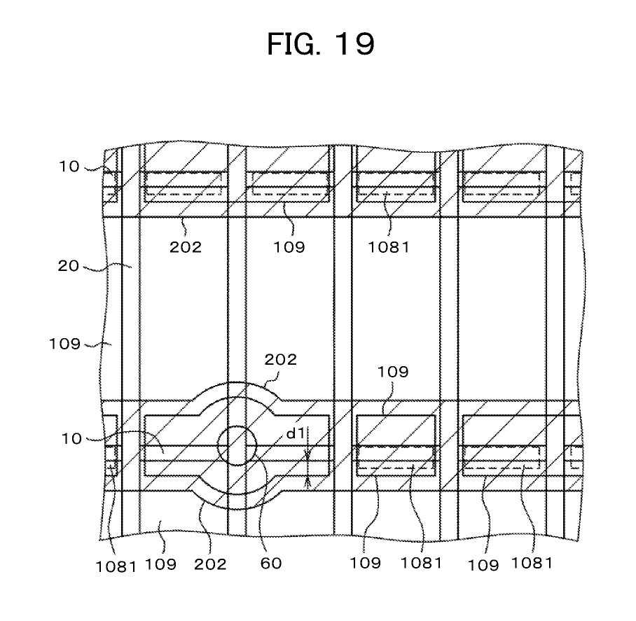

FIG. 19 is a plan view showing another implementation of the second embodiment. FIG. 19 is different from FIG. 18 in that the organic passivation film concave portion 1081 is formed separately with respect to each organic passivation film concave portion 1081. That is, the organic passivation film 108 is left between the concave portions 1081 formed with respect to each pixel. When the alignment of the liquid crystal is strongly affected by the concave portion 1081, such a configuration as shown in FIG. 19 may be employed.

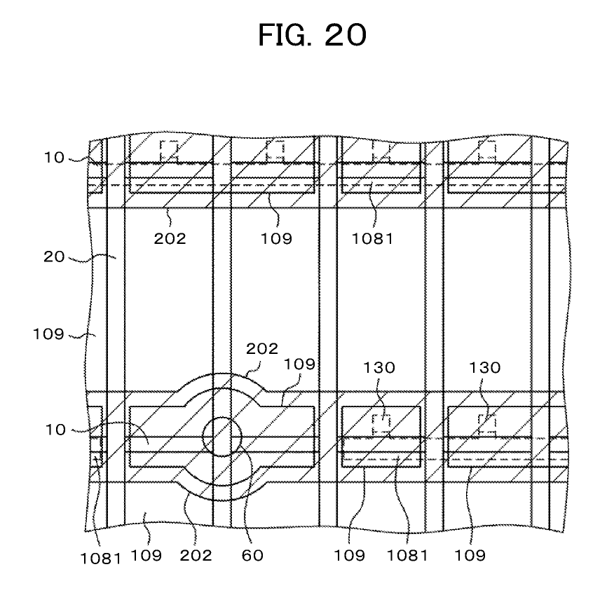

FIG. 20 is a plan view showing still another implementation of the second embodiment. FIG. 20 is different from FIG. 18 in that the through-hole 130 organic passivation film concave portion 1081 in the pixel are formed continuously. That is, this implementation is similar to the cross-sectional view shown in FIG. 15.

Because the organic passivation film 108 is thick, the diameter of the through-hole 130 is made large. When forming the through-hole 130 and the concave portion 1081 of the organic passivation film 108 separately, it is not possible to increase the transmission of the pixel itself. Therefore, linking the through-hole 130 to the organic passivation film concave portion 1081 as described in this embodiment eliminates the need of forming a bank for isolation, thereby improving the transmission of the pixel.

In this manner, according to this embodiment, it is possible to further improve the ion trapping effect, thereby preventing the black stain derived from ion accumulation. Furthermore, it is also possible to form the organic passivation film concave portion 1081 in the organic passivation film 108 at the same time as forming the through-hole 130 in this embodiment, which minimizes increase in production cost.

Although the case of the top-gate TFT was generally described above, the present invention can be similarly applied to the case of the bottom-gate TFT. Furthermore, although the description was given with the case of the IPS system having the common electrode on the bottom side and the pixel electrode on the top side, the invention can be applied to the IPS system having the pixel electrode on the bottom side and the common electrode on the top side. Moreover, although the IPS liquid crystal display device was described above, the present invention can be applied to other liquid crystal display devices that are not based on the IPS system.

What is claimed is:

1. A liquid crystal display device comprising: a TFT substrate comprising a plurality of scanning lines, a plurality of image signal lines extending in a second direction, and a plurality of switching elements formed on each pixel; a counter substrate; and a liquid crystal layer sandwiched between the TFT substrate and the counter substrate, wherein
a common electrode is formed on a side of the image signal line facing the liquid crystal layer via an insulating film,
the common electrode is formed continuously across a plurality of pixels along an extending direction of the scanning lines as viewed from above and also has a gap at a position superimposed on the scanning line, an end portion of the common electrode is arranged with a space d1 from the scanning line as seen from above, and when a distance between the scanning-line forming layer and the common-electrode forming layer is assumed h1 as seen in a sectional view of the TFT substrate, the space d1 between the scanning line and the end portion of the common electrode is larger than the distance h1.

2. The liquid crystal display device according to claim 1, wherein the space d1 between the scanning line and the end portion of the common electrode is 3 μm or more.

3. The liquid crystal display device according to claim 1, wherein the insulating film is an organic insulating film.

4. The liquid crystal display device according to claim 1, wherein a columnar spacer defining a space between the TFT substrate and the counter substrate is formed between a first pixel and a second pixel, and the columnar spacer is not superimposed on the common electrode.

5. The liquid crystal display device according to claim 1, wherein the space between the scanning line and the common electrode is larger in a portion where the columnar spacer is formed than in a portion where the columnar spacer is not formed.

6. A liquid crystal display device comprising: a TFT substrate comprising a plurality of scanning lines, a plurality of image signal lines, and a plurality of switching elements formed on each pixel; a counter substrate; and a liquid crystal layer sandwiched between the TFT substrate and the counter substrate, wherein
a first electrode is formed on a side of the image signal line facing the liquid crystal layer via a first insulating film,
a second electrode is formed on the first electrode with a second insulating film interposed in between,
either one of the first electrode and the second electrode is a common electrode,
the common electrode is formed continuously across a plurality of pixels along an extending direction of the scanning lines as viewed from above and also has a gap at a position superimposed on the scanning line, an end portion of the common electrode is arranged with a space d1 from the scanning line as seen from above,
and the liquid crystal display device comprises at a position of the gap d1 a concave region where the first insulating film is thinner.

7. The liquid crystal display device according to claim 6, wherein a depth of the concave region of the first insulating film is 1 μm or more.

8. The liquid crystal display device according to claim 6, wherein a depth of the concave region of the first insulating film is ⅓ or more of a thickness of the first insulating film.

9. The liquid crystal display device according to claim 6, wherein the space d1 is 3 μm or more.

10. The liquid crystal display device according to claim 6, wherein a columnar spacer defining a space between the TFT substrate and the counter substrate is formed between a first pixel and a second pixel, and the columnar spacer is not superimposed on the common electrode.

11. The liquid crystal display device according to claim 6, wherein the space d1 between the scanning line and the common electrode is larger in a portion where the columnar spacer is formed than in other portions.

12. The liquid crystal display device according to claim 10, wherein the concave region of the first insulating film is not formed in the first pixel and the second pixel.

13. The liquid crystal display device according to claim 6, wherein a through-hole that connects the first or second electrode that is not the common electrode to the switching element is formed in the first insulating film, and the through-hole and the concave region of the first insulating film are formed continuously.

14. The liquid crystal display device according to claim 6, wherein the concave region of the first insulating film is formed continuously between adjacent pixels.

15. The liquid crystal display device according to claim 6, wherein the first insulating film is an organic insulating film.

16. The liquid crystal display device according to claim 1, wherein the liquid crystal display device employs the IPS system.

17. The liquid crystal display device according to claim 6, wherein the liquid crystal display device employs the IPS system.
